(19) United States
(12) Patent Application Publication
(10) Pub. No.: US 2015/0244898 A1
(43) Pub. Date: Aug. 27, 2015

(54) IMAGE PROCESSING APPARATUS, METHOD FOR CONTROLLING THE SAME, AND STORAGE MEDIUM

(71) Applicant: CANON KABUSHIKI KAISHA, Tokyo (JP)

(72) Inventor: Yasutomo Tanaka, Kawasaki-shi (JP)

(21) Appl. No.: 14/618,307

(22) Filed: Feb. 10, 2015

(30) Foreign Application Priority Data
Feb. 26, 2014 (JP) 2014-035996

(51) Int. Cl. H04N 1/32; H04N 1/00

(52) U.S. Cl. CPC H04N 1/32496; H04N 1/0083; H04N 1/32603; H04N 1/32593; H04N 1/32587; H04N 2201/0094; H04N 2201/33307

(57) ABSTRACT

An image processing apparatus determines a status when being activated, and reconfigures a circuit arrangement for executing a job that is highly likely to be instructed on a reconfigurable circuit. When a job is accepted, the image processing apparatus reconfigures, if the job is not executable by a circuit arrangement configured on the reconfigurable circuit, a circuit arrangement that is needed for executing the job on the reconfigurable circuit, and executes the accepted job.

### BACKGROUND OF THE INVENTION

1. Field of the Invention

The present invention relates to an image processing apparatus, a method for controlling the same, and a storage medium.

2. Description of the Related Art

Reconfigurable circuits such as a Programmable Logic Device (PLD) and a Field Programmable Gate Array (FPGA) in which an arrangement of a logic circuit is changeable are widely known. Ordinarily, changing a logic circuit of a PLD or FPGA is realized by writing circuit arrangement information stored in a nonvolatile memory such as a ROM into a configuration memory that is a volatile memory provided inside the PLD or FPGA at the time of start-up. Furthermore, since the information in the configuration memory is cleared at the time of power-off, the circuit arrangement information stored in the ROM needs to be written again into the configuration memory at the time of power-on. Accordingly, the method of configuring a logic circuit of a PLD or FPGA only once in the state in which a power is supplied is referred to as static reconfiguration. In contrast, a FPGA and the like in which an arrangement of a logic circuit can dynamically be changed under the operation of the logic circuit have been developed, and such a method of dynamically changing a logic circuit is referred to as dynamic reconfiguration.

Furthermore, there are some FPGAs in which instead of the circuit arrangement of the entire chip of the FPGA, a circuit arrangement only in a specific region thereof can be rewritten, and such rewriting is referred to as partial reconfiguration. Particularly, changing, without stopping an operation of an operating circuit, the arrangement of the remaining circuit other than the operating circuit is referred to as dynamic partial reconfiguration. In the dynamic partial reconfiguration, it is possible to partially reconfigure a logic circuit of a FPGA by rewriting not the entire configuration memory but only a part of the configuration memory at the time of dynamic reconfiguration. By using such dynamic partial reconfiguration, it is possible to implement a plurality of logic circuits on a region of the FPGA while switching the logic circuits in a time division manner, for example. As a result, it is possible to flexibly realize various functions according to uses with a small amount of hardware resources, while maintaining high-speed computing performance by hardware.

However, although a circuit arrangement can be changed during the operation, it takes long time to change (rewrite) the circuit arrangement, and the time is proportional to the size of logic circuit arrangement information that is to be written into a configuration memory. Therefore, a technique for reducing the time for rewriting a circuit arrangement has been proposed.

Japanese Patent Laid-Open No. 2011-186981 proposes, as a technique for reducing a rewriting time, a technique in processing of a pipeline configuration in which partial circuits are reconfigured on a reconfigurable circuit in order from the circuit at the head of the pipeline. Accordingly, activation in order from the reconfigured partial circuit is possible, and it is possible to perform data processing with a higher speed than the case where simultaneously reconfigurable circuits are reconfigured together on a reconfigurable circuit and activated.

Furthermore, an image processing apparatus such as a Multi-Function Printer (MFP) can select a plurality of types of processing (such as a copy job, a print job, and a send job) in accordance with requests from a user, and each type of image processing is realized by hardware or software. Furthermore, recent MFPs have a power saving state in view of a reduction in power consumption, and have the function of shifting to the power saving state when the MFP has not been accessed in a predetermined time period, and of being restored from the power saving state when the MFP is again to be used.

However, the above-described technique has the above-described problems. For example, when the conventional reconfiguration technique is applied to an image processing unit of an image processing apparatus, a circuit arrangement for image processing is rewritten at a timing after a processing content is settled. For example, in a case where a copy job is to be executed, a user rewrites a circuit arrangement for image processing that is needed for execution of the copy job, when pressing down a copy execution start button and starting copy processing. In this case, there is the problem that time for rewriting a circuit arrangement is needed in contrast to a system having dedicated hardware, and an actual start of the processing is delayed, deteriorating the user's convenience.

### SUMMARY OF THE INVENTION

The present invention enables realization of an image processing apparatus in which dynamic partial reconfiguration is possible, the image processing apparatus having a mechanism in which execution of high-speed processing is achieved after a user gives an instruction by predicting a function that is next to be executed based on a connection interface of an image processing apparatus and a restoration factor that restores the image processing apparatus from a power saving state, and reconfiguring in advance a circuit arrangement that is to be needed.

One aspect of the present invention provides an image processing apparatus including a reconfigurable circuit in which a part of a circuit arrangement is dynamically reconfigurable, the image processing apparatus comprising: a status determination unit configured to determine a status when the image processing apparatus is activated; a first reconfiguration unit configured to reconfigure a circuit arrangement for executing a job that is highly likely to be instructed from a circuit arrangement that has already been configured on the reconfigurable circuit based on the status determined by the status determination unit; an accepting unit configured to accept a job; a second reconfiguration unit configured to reconfigure, if the job accepted by the accepting unit is not executable by the circuit arrangement configured on the reconfigurable circuit, a circuit arrangement that is needed for execution of the job on the reconfigurable circuit; and an execution unit configured to execute the job accepted by the accepting unit.

Another aspect of the present invention provides a method for controlling an image processing apparatus including a reconfigurable circuit in which a part of a circuit arrangement is dynamically reconfigurable, the method comprising the steps of: determining a status when the image processing apparatus is activated; firstly reconfiguring a circuit arrangement for executing a job that is highly likely to be instructed from a circuit arrangement that has already been configured on the reconfigurable circuit based on the status determined in the determining; accepting a job; secondly reconfiguring, if the job accepted in the accepting is not executable by the circuit arrangement configured on the reconfigurable circuit, a circuit arrangement that is needed for executing the job on the reconfigurable circuit; and executing the job accepted in the accepting.

Still another aspect of the present invention provides a non-transitory computer-readable storage medium storing a computer program causing a computer to function as the image processing apparatus.

Further features of the present invention will be apparent from the following description of exemplary embodiments with reference to the attached drawings.

### BRIEF DESCRIPTION OF THE DRAWINGS

FIG. 1 is a block diagram showing an example of a configuration of an image processing apparatus according to a first embodiment.

FIG. 2 is a diagram showing functions of the image processing apparatus according to the first embodiment, and examples of configurations of image processing functions that are configured on a dynamic reconfiguration unit.

FIG. 3 is a flowchart showing the reconfiguration control of the image processing unit when the image processing apparatus according to the first embodiment is turned on.

FIG. 4 is a flowchart showing job execution control when the image processing apparatus according to the first embodiment is turned on.

FIG. 5 is a flowchart showing the reconfiguration control of an image processing unit of an image processing apparatus according to a second embodiment when it is restored from a power saving state.

FIG. 6 is a flowchart showing job execution control of the image processing apparatus according to the second embodiment.

FIG. 7 illustrates a priority order in a case where a plurality of interface cables are connected.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

### Configuration of Image Processing Apparatus

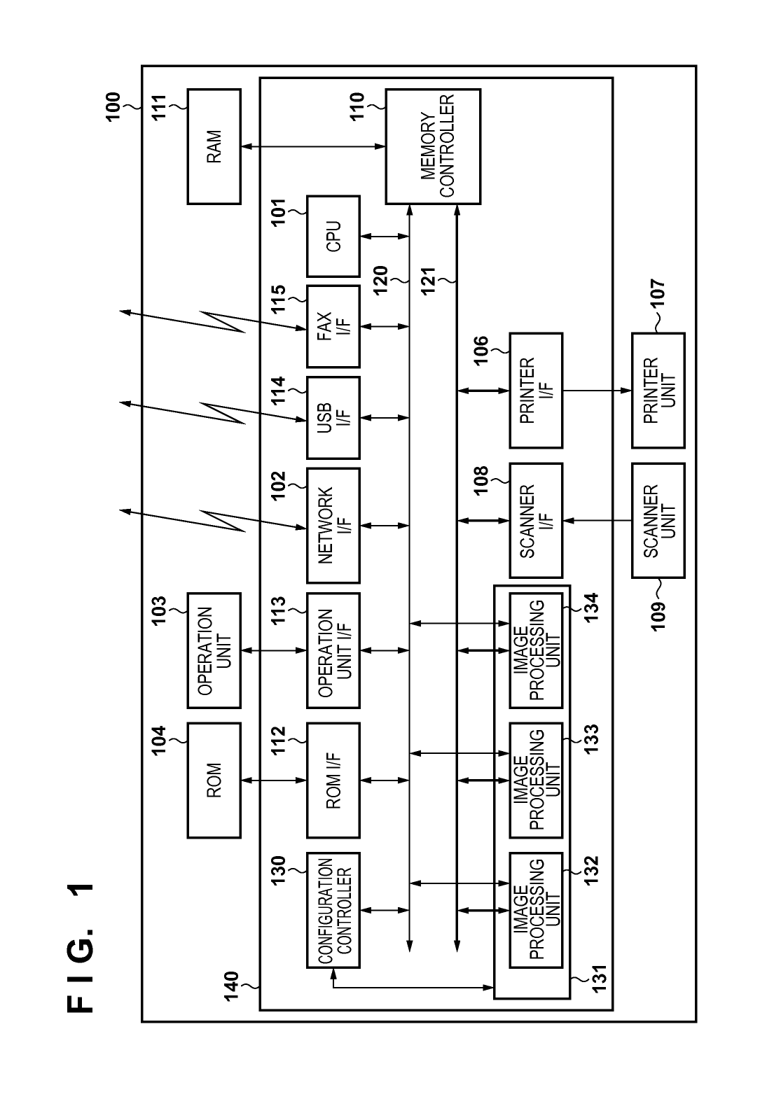

Hereinafter, a first embodiment of the present invention will be described with reference to FIGS. 1 to 4. First, reference will be made to FIG. 1, which is a block diagram illustrating an apparatus configuration of an image processing apparatus according to the embodiment of the present invention. The present embodiment will be described assuming that an image processing apparatus 100 is a multi-function printer (multi-function processing apparatus) including a scanner unit and a printer unit.

The image processing apparatus 100 includes an operation unit 103 with which a user of the image processing apparatus 100 performs various types of operations, a scanner unit 109 that reads image information of an original document, and a printer unit 107 that prints an image on a sheet based on image data. The scanner unit 109 includes a CPU for controlling the scanner unit 109, an illumination lamp and a scanner mirror that are used for reading an original document, and the like. The printer unit 107 includes a CPU for controlling the printer unit 107, a photoreceptor drum for forming (printing) an image, a fixer for fixing an image, and the like. The operation unit 103 includes a power saving key, and shifts and restores the image processing apparatus 100 to and from a power saving state by the power saving key being pressed down.

Furthermore, the image processing apparatus 100 includes an FPGA 140 provided with a dynamic reconfiguration unit (reconfigurable circuit), as a controller for controlling the image processing apparatus 100. In this example, the FPGA 140 includes a CPU 101 for performing overall control of the operation of the image processing apparatus 100. This CPU 101 executes a program for controlling the FPGA 140 and a configuration controller (a first reconfiguration unit and a second reconfiguration unit) 130 for controlling reconfiguration, and the like. Note that it is merely an example that the FPGA 140 includes the CPU 101, and the CPU may also be provided on the outside of the FPGA 140.

Furthermore, the image processing apparatus 100 includes a ROM 104 in which a boot program that is executed by the CPU 101, and logic circuit arrangement information that is used for configuring the FPGA 140 are stored. Moreover, the image processing apparatus 100 includes a RAM 111 that serves as a system work memory on which the CPU 101 operates, and also as an image memory for temporarily storing image data. Furthermore, the RAM 111 also serves as a memory in which logic circuit arrangement information stored in the ROM 104 is copied and stored, so that the logic circuit arrangement information is read at a high-speed.

The FPGA 140 includes the CPU 101, a network I/F 102, a printer I/F 106, a scanner I/F 108, a memory controller 110, a ROM I/F 112, an operation unit I/F 113, a USB I/F 114, a FAX I/F 115, a configuration controller 130, and a dynamic reconfiguration unit 131. The dynamic reconfiguration unit 131 is dynamically reconfigurable (rewritable), and partially rewritable. That is, while a circuit reconfigured on a part of the dynamic reconfiguration unit 131 is operating, another circuit can be reconfigured on another part that does not overlap with the part on which that circuit is provided. The dynamic reconfiguration unit 131 includes an image processing unit 132, an image processing unit 133, and an image processing unit 134 on which logic circuits for performing various types of image processing can partially be reconfigured. Note that the present embodiment shows an aspect in which three image processing units are provided in the dynamic reconfiguration unit 131, but the number of the image processing units is not limited to three. The configuration controller 130 controls a circuit arrangement (configuration) of the dynamic reconfiguration unit 131.

The scanner I/F 108 is an interface on which image data is input from the scanner unit 109. The printer I/F 106 is an interface from which image data is output to the printer. The image processing units 132, 133, and 134 of the dynamic reconfiguration unit 131, and the scanner I/F 108, and the printer I/F 106 are connected to an image bus 121 via which image data that is to be processed is transferred.

The CPU 101 performs overall control of the operation of the image processing apparatus 100, and communicates with (performs transmission to and reception from) a general-purpose computer on a network via the network I/F (network interface) 102. Furthermore, the CPU 101 communicates with (performs transmission to and reception from) a general-purpose computer that is connected to the image processing apparatus 100 via the USB I/F (USB interface) 114. Furthermore, the CPU 101 is connected to a telephone public circuit network via the FAX I/F (facsimile interface) 115, and communicates with (performs transmission to and reception from) another image processing apparatus or facsimile apparatus. The FAX I/F 115 encompasses a CI detection circuit for detecting a calling signal (Call Indicator (CI) signal) from the telephone public circuit network. The ROM I/F 112 controls operations of writing into and reading from the ROM 104 in which a boot program that is executed by the CPU 101, and logic circuit arrangement information (configuration data) that is used for configuring the dynamic reconfiguration unit 131 are stored.

Furthermore, the FPGA 140 includes a system bus 120 that connects the CPU 101, the network I/F 102, the operation unit 103, the ROM I/F 112, the configuration controller 130, and the dynamic reconfiguration unit 131 to each other. The CPU 101 performs, via the system bus 120, setting of parameters of the image processing units 132, 133, and 134 that are configured in the dynamic reconfiguration unit 131, and the scanner I/F 108, and the printer I/F 106. The RAM 111 serves as a system work memory on which the CPU 101 operates, and also as an image memory in which image data is temporarily stored, the RAM 111 serving also as a memory in which logic circuit arrangement information stored in the ROM 104 is copied and stored, so that the circuit arrangement information is read at a high-speed. The memory controller 110 controls the operations of writing into and reading from the RAM 111. The memory controller 110 is connected to the system bus 120 and the image bus 121, and exclusively switches access to the RAM 111 from the bus master connected to the image bus 121 to access to the RAM 111 from the bus master connected to the system bus 120.

Image Processing Function that is Configured on Dynamic Reconfiguration Unit

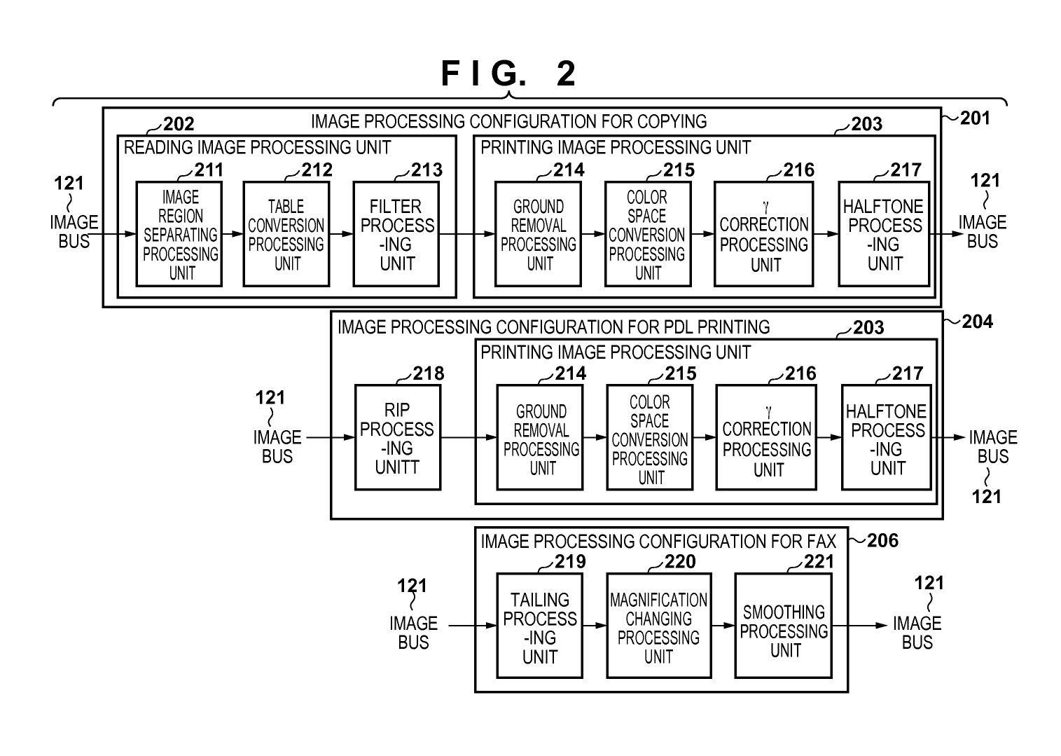

The following will describe image processing functions that are configured on the dynamic reconfiguration unit 131 of the image processing apparatus 100 according to the present embodiment with reference to FIG. 2. The image processing apparatus 100 has the function (copy job) of copying an original document read by the scanner unit 109, and the function (PDL print job) of printing print data transmitted from an external printer driver. The image processing apparatus 100 further has the function (facsimile job) of printing facsimile data received from the FAX I/F 115. In the case of an image processing system to which a dynamic reconfiguration technique is applied, the image processing function that is needed in accordance with the function selected by a user is configured on the dynamic reconfiguration unit 131, and actual processing is executed.

The reference numeral 201 denotes an image processing configuration for copying that shows an image processing function that is configured on the dynamic reconfiguration unit 131 at the time of execution of a copy job. The copy job image processing configuration 201 can be divided into a reading image processing unit 202 and a printing image processing unit 203. At the time of execution of a copy job, image data that was input into the scanner unit 109 is input into the reading image processing unit 202.

The reading image processing unit 202 is constituted by, for example, an image region separating processing unit 211, a table conversion processing unit 212, and a filter processing unit 213. The image region separating processing unit 211 determines an image region by detecting a character part from an input image, and generates an image region signal for use in image processing that is to be performed later. The table conversion processing unit 212 performs table conversion for converting image data that is read brightness data into density data. The filter processing unit 213 performs, for example, computing processing using a digital space filter in accordance with a purpose such as edge reinforcement. The image data on which the above-described reading image processing is completely performed is transferred to the printing image processing unit 203 via the image bus 121. The image data may also be transferred to the printing image processing unit in a pipeline manner, instead of being transferred to the image bus 121.

The printing image processing unit 203 includes a ground removal processing unit 214, a color space conversion processing unit 215, a γ correction processing unit 216, and a halftone processing unit 217. The ground removal processing unit 214 performs processing for removing a background color when image data obtained by reading an original document having a light color background is transmitted. The color space conversion processing unit 215 performs conversion of RGB data to CMYK data depending on output characteristics of the image processing apparatus. The γ correction processing unit 216 performs density conversion of the image data. The halftone processing unit 217 performs halftone processing on data of each color. Specific configurations of the halftone processing unit include a configuration of screen processing or a configuration of error diffusion processing. In the screen processing, N-values are obtained using a predetermined plurality of dither matrices and input image data. Furthermore, the error diffusion processing is processing in which an N-value is obtained by comparing input image data with a predetermined threshold, and a difference between the input image data and the threshold at that time is diffused to surrounding pixels that are to be used for obtaining N-values later.

The image data on which the above-described printing image processing is completely performed is transferred to the printer I/F 106 via the image bus 121, and is output from the printer unit 107. The above-described processing procedure is of course an example, and it is also possible to configure another image processing function on the dynamic reconfiguration unit 131 and perform corresponding processing.

The reference numeral 204 denotes an image processing configuration for PDL printing that shows an image processing function that is configured on the dynamic reconfiguration unit 131 at the time of execution of a PDL print job. The PDL print job image processing configuration 204 is constituted by an RIP (raster image processor) processing unit 218 and the printing image processing unit 203. The RIP processing unit 218 expands Print Description Language (PDL) data included in a print job received from a general-purpose computer connected via the network I/F 102 into a bitmap image. At the time of execution of a PDL print job, PDL data that was input from the general-purpose computer is first input into the RIP processing unit 218, and is converted into a bitmap image. The image data converted into the bitmap image is input into the printing image processing unit 203, and is subjected to the already described processing by the ground removal processing unit 214, the color space conversion processing unit 215, the γ correction processing unit 216, and the halftone processing unit 217.

Although, here, the printing image processing unit at the time of execution of a copy job, and the printing image processing unit at the time of execution of a PDL print job are configured to include the same functions, a different type of hardware may also be selected and configured for a PDL job. Hardware different from that at the time of execution of a copy job may be configured for a PDL job such that, for example, the halftone processing unit 217 performs the error diffusion processing at the time of execution of a copy job, and performs the halftone processing using screen processing at the time of PDL printing.

The image data on which the above-described printing image processing is completely performed is transferred to the printer I/F 106 via the image bus 121, and is output from the printer unit 107. The above-described flow is, of course, merely an example, and another image processing function may also be configured and implemented on the dynamic reconfiguration unit 131.

The reference numeral 206 denotes an image processing configuration for facsimile that shows an image processing function that is configured on the dynamic reconfiguration unit 131 at the time of receiving a FAX job. The FAX image processing configuration 206 is constituted by a tailing processing unit 219, a magnification changing processing unit 220, and a smoothing processing unit 221. When a FAX job is received, image data that was input from the telephone public circuit via the FAX I/F 115 is input into the tailing processing unit 219. The tailing processing unit 219 performs processing for appropriately thinning pixels from the image data in order to prevent fixing explosion. Then, the image data is input into the magnification changing processing unit 220. The magnification changing processing unit 220 performs resolution conversion for converting the image data received from the telephone public circuit so that the resolution of the image data is equal to the resolution of the image processing apparatus 100. The smoothing processing unit 221 performs processing for smoothing jaggies (roughness of an image that appears at the border, such as a diagonal line, between white and black areas) of the image data whose resolution has been converted.

The image data on which the above-described FAX image processing is completely performed is transferred to the printer I/F 106 via the image bus 121, and is output from the printer unit 107. The above-described FAX image processing is, of course, merely an example, and another image processing function may also be configured and implemented on the dynamic reconfiguration unit 131.

In the present embodiment, image processing is performed by suitably configuring a corresponding image processing function described with reference to FIG. 2 on the dynamic reconfiguration unit 131. Note that the jobs that can be processed by the image processing apparatus 100 are not limited to those shown in FIG. 2. Furthermore, the unit of image processing is not limited to that shown in FIG. 2, and it is also possible to divide processing included in each type of image processing into more fine components.

Reconfiguration Control

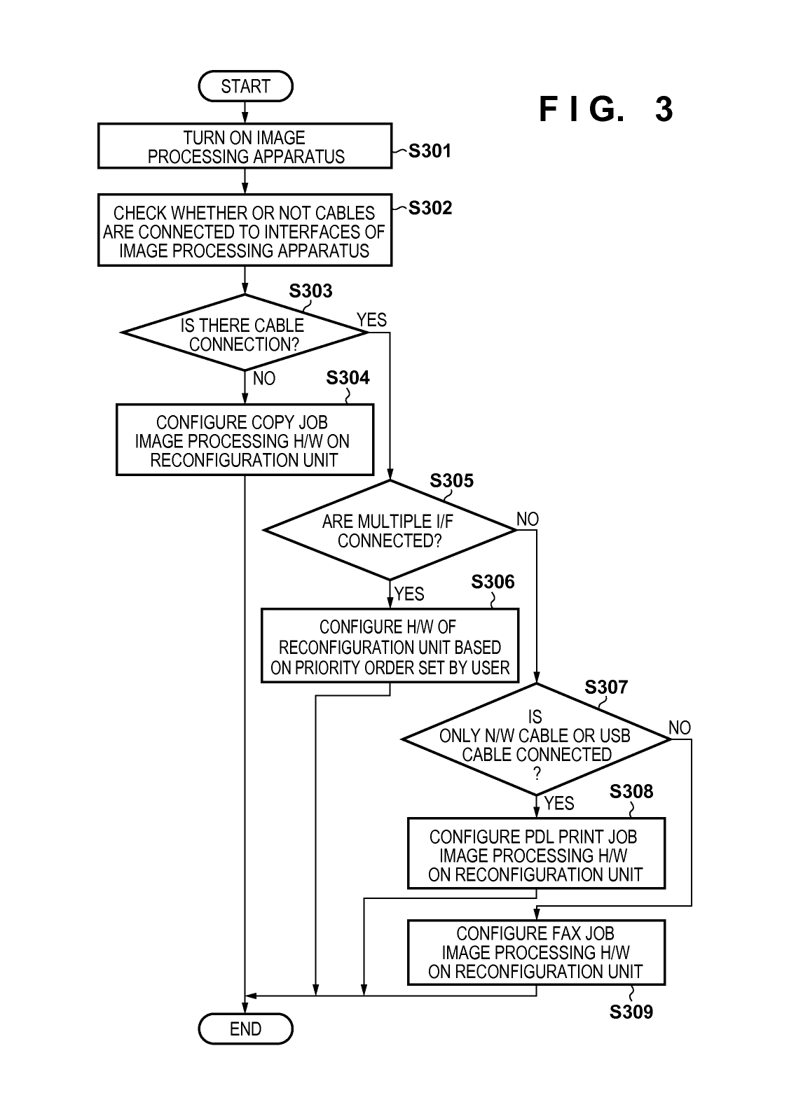

The following will describe the processing procedure of reconfiguration control performed by the image processing units when the image processing apparatus according to the present embodiment is turned on, with reference to FIG. 3. The procedure described below is realized by the CPU 101 executing a control program stored in the ROM 104 on the RAM 111.

First, in step S301, the image processing apparatus 100 is turned on (ON) and power is supplied thereto, that is, the image processing apparatus 100 is activated. Then, in step S302, the CPU 101 functions as a status determination unit, and checks whether or not cables are connected to the respective types of interfaces (the network I/F 102, the USB I/F 114, and the FAX I/F 115). Here, the cable connection status when the image processing apparatus 100 is turned on and activated is determined, and specifically, existence or absence of a cable that is connected, and the type of the connected cable are determined. In step S303, the CPU 101 determines based on the result of step S302 whether or not there is cable connection, and if it is determined that there is no cable connection, the procedure advances to step S304, and if it is determined that there is cable connection, the procedure advances to step S305.

In step S304, since there is no cable connection in the image processing apparatus 100, the CPU 101 lets the configuration controller 130 reconfigure the copy job image processing configuration 201 shown in FIG. 2 from a circuit arrangement already configured on the dynamic reconfiguration unit 131. Here, in the present embodiment, in the case where there is no cable connection, it is determined that a copy job is most likely to be executed, and the copy job image processing configuration 201 is reconfigured in advance on the dynamic reconfiguration unit 131. However, the present invention is not limited to this, and contents of the configuration may be changed according to the installation environment and use history of the image processing apparatus 100, settings by a user, or the like.

In step S305, the CPU 101 determines whether or not there are a plurality of types of cables connected to the image processing apparatus. As a result of the determination in step S305, if it is determined that there are a plurality of types of cables connected to the image processing apparatus 100, the procedure advances to step S306, and if it is determined that there is only one type of cable connected thereto, the procedure advances to step S307.

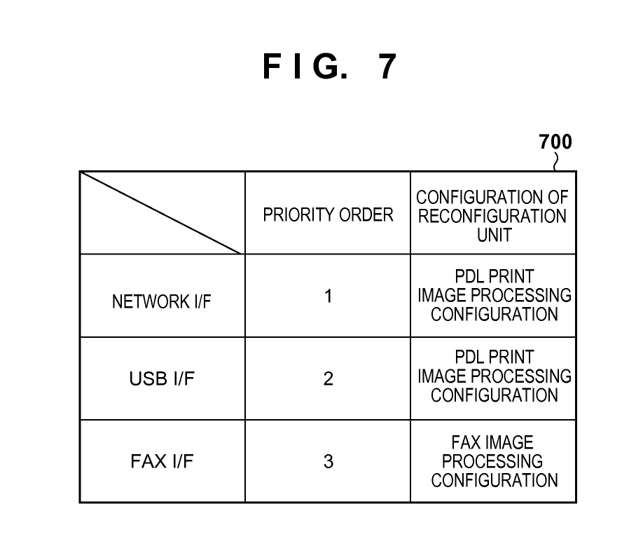

In step S306, the CPU 101 lets the configuration controller 130 reconfigure the image processing unit of the dynamic reconfiguration unit 131 according to a priority order of the connected interfaces shown in FIG. 7.

Hereinafter, a priority order when cables are respectively connected to a plurality of interfaces and image processing configurations that are to be reconfigured on the dynamic reconfiguration unit 131 will be described with reference to FIG. 7. FIG. 7 shows a table 700 in which the priority order of the interfaces included in the image processing apparatus 100, and the image processing configurations that are to be configured on the dynamic reconfiguration unit 131 are associated with each other. The table 700 is stored (held) in advance in the ROM 104 or the like. For example, when cables are connected to both the network I/F 102 and the FAX I/F 115 when the image processing apparatus 100 is turned on, an image processing configuration that is to be reconfigured on the dynamic reconfiguration unit 131 is decided with reference to this table. In the table 700, the network I/F 102 has higher priority than the FAX I/F, and thus the network I/F takes precedence and the PDL print job image processing configuration is reconfigured. The priority order at that time may be decided in advance by the image processing apparatus or may be set by a user.

The description will return to FIG. 3. In step S307, the CPU 101 determines whether or not a cable is connected to only one of the network I/F 102 and the USB I/F 114. As a result of the determination in step S307, if it is determined that a cable is connected to only one of the network I/F 102 and the USB I/F 114, the procedure advances to step S308, and otherwise to step S309.

In step S308, since a cable is connected to the network I/F 102 or the USB I/F 114, the CPU 101 lets the configuration controller 130 reconfigure the PDL print job image processing configuration 204 on the dynamic reconfiguration unit 131. On the other hand, in step S309, since a cable is connected only to the FAX I/F 115 as an interface of the present embodiment, the CPU 101 lets the configuration controller 130 reconfigure the FAX image processing configuration 206 on the dynamic reconfiguration unit 131. Note that in the processing in steps S304, S306, S308, and S309 in the present flowchart, the configuration controller 130 functions as a first reconfiguration unit.

As described above, although, in the present flowchart, the image processing function that is to be reconfigured according to the type of a cable connected to the image processing apparatus 100 is described with reference to the configuration shown in FIG. 2, the present invention is not limited to this.

Job Execution Control

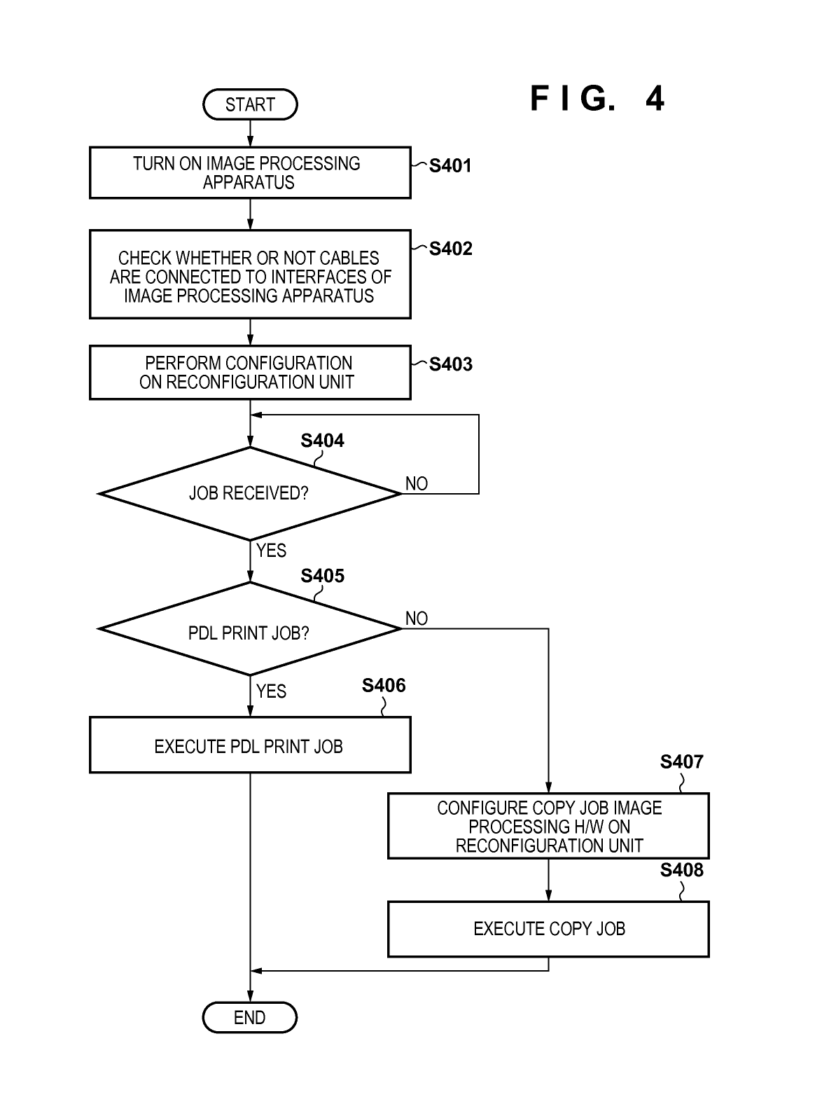

The following will describe the processing procedure of job execution control when the image processing apparatus 100 according to the present embodiment is turned on with reference to FIG. 4. FIG. 4 illustrates, as an example, the processing procedure when the image processing apparatus 100 according to the present embodiment is turned on in the state in which a cable is connected only to the network I/F 102, and then a job is accepted. The processing that will be described below is realized by the CPU 101 executing a control program stored in the ROM 104 on the RAM 111.

First, in step S401, the image processing apparatus 100 is turned on, and power is supplied thereto. In step S402, the CPU 101 checks whether or not cables are connected to the respective types of interfaces. Here, the flow progresses assuming that the cable is connected only to the network I/F.

In step S403, as a result of step S402, the CPU 101 lets the configuration controller 130 reconfigure the PDL print job image processing configuration 204 on the dynamic reconfiguration unit 131. Here, the PDL print job image processing configuration 204 that is to be reconfigured is selected in accordance with the priority order of the interfaces defined in the table 700.

In step S404, the CPU 101 functions as an accepting unit, and determines whether or not the image processing apparatus 100 has received a job. If it is determined in step S404 that the image processing apparatus 100 has received a job, the procedure advances to step S405, and if it is determined that the image processing apparatus 100 has not received a job, the determination in step S404 is repeated regularly.

In step S405, the CPU 101 determines whether or not the received job is a PDL print job. If the CPU 101 has determined in step S405 that the received job is a PDL print job, the procedure advances to step S406, and if it is determined that the received job is not a PDL print job, the procedure advances to step S407. In step S406, the CPU 101 starts processing of the PDL print job since the PDL print job image processing configuration 204 is already reconfigured on the dynamic reconfiguration unit 131 in step S403.

On the other hand, in step S407, the CPU 101 lets the configuration controller 130 reconfigure the image processing unit that is needed for processing the job received in step S404 on the dynamic reconfiguration unit 131. Here, the configuration controller 130 functions as a second reconfiguration unit. In the case where, for example, a copy job is received, the copy job image processing configuration 201 is reconfigured. Then, in step S408, the CPU 101 starts processing of the job received in step S404. If, for example, the job received in step S404 is a copy job, processing of a copy job is started.

As described above, the image processing apparatus according to the present embodiment predicts an appropriate image processing function based on existence or absence and the type of an interface that is connected to the image processing apparatus when it is turned on, and reconfigures that function on the dynamic reconfiguration unit 131 in advance. According to the present embodiment, it is thus possible to immediately start processing when a job execution instruction is given. Note that in the case where the prediction fails, it is possible to perform processing with an appropriate configuration by rewriting again the dynamic reconfiguration unit 131.

### Second Embodiment

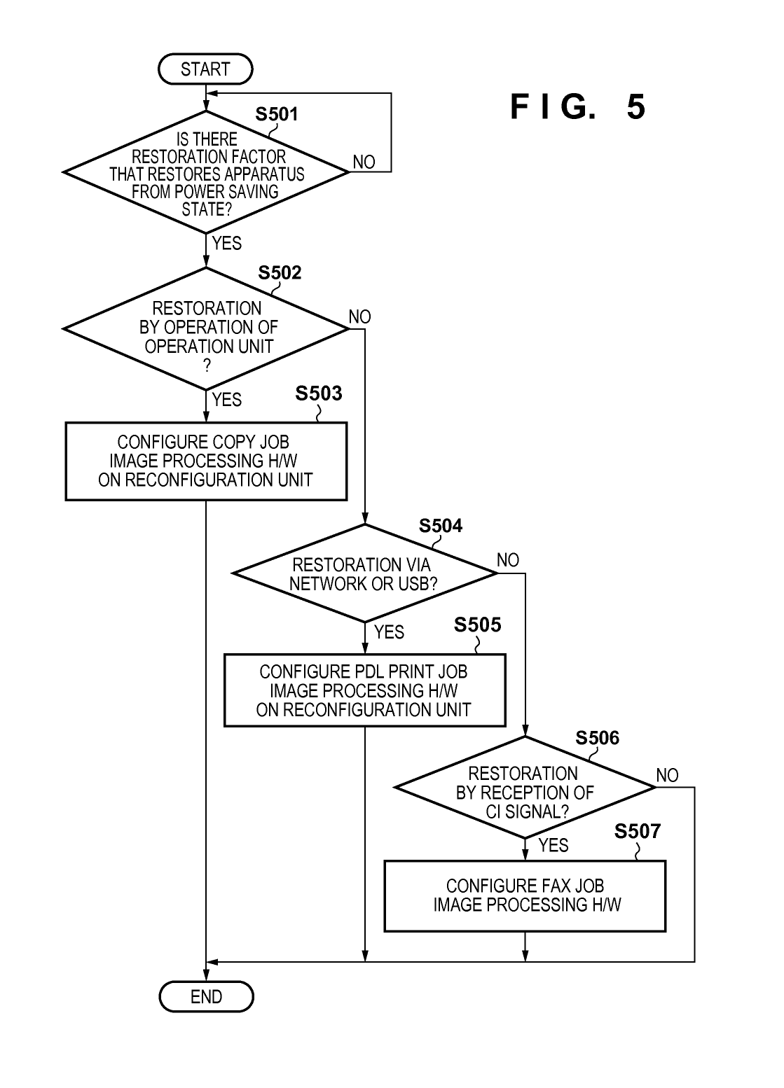

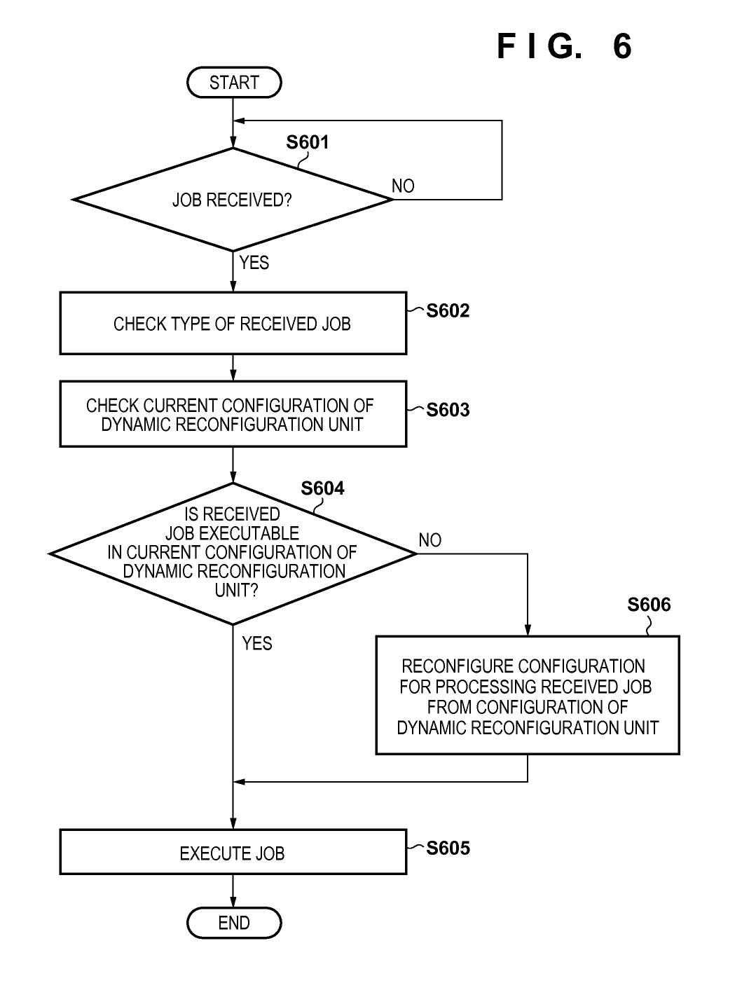

Hereinafter, a second embodiment of the present invention will be described with reference to FIGS. 5 and 6. The above-described first embodiment has described the reconfiguration control of the image processing units when the image processing apparatus 100 is turned on. The present embodiment will describe reconfiguration control and job execution control of the image processing units when the image processing apparatus 100 is restored from a power saving state. Note that descriptions of the same configuration and control as those of the first embodiment will be omitted. Furthermore, the present embodiment may also be realized in combination with the first embodiment.

Reconfiguration Control

First, the processing procedure of the reconfiguration control of the image processing units when the image processing apparatus 100 according to the present embodiment is restored from a power saving state will be described with reference to FIG. 5. Furthermore, the present flowchart starts with the power saving state. The processing that will be described below is realized by the CPU 101 executing a control program stored in the ROM 104 on the RAM 111.

First, in step S501, the CPU 101 determines whether or not there is a restoration factor that restores the image processing apparatus 100 from the power saving state. Restoration factors that restores the image processing apparatus 100 from the power saving state according to the present embodiment are broadly classified into a factor that a power saving key of the operation unit 103 is pressed down, a factor that data is received from the network I/F 102 or the USB I/F 114, and a factor that a calling signal (CI signal) is received from the telephone public circuit.

If it is determined in step S501 that there is a restoration factor that restores the image processing apparatus 100 from the power saving state, the procedure advances to step S502, and if there is not the factor, the determination in step S501 is repeated regularly. In step S502, the CPU 101 determines whether or not the restoration factor is that the power saving key of the operation unit 103 is pressed down. If the result of step S502 shows the restoration by the power saving key of the operation unit 103 being pressed down, the procedure advances to step S503, and if restoration is caused by another factor, the procedure advances to step S504.

In step S503, the CPU 101 lets the configuration controller 130 reconfigure the copy job image processing Configuration 201 on the dynamic reconfiguration unit 131. Here, the reason why the copy job image processing Configuration 201 is reconfigured is that the user is likely to execute a copy job since the restoration factor that restores the image processing apparatus from the power saving state is the operation of the operation unit 103, and a user is present in front of the image processing apparatus.

On the other hand, in step S504, the CPU 101 determines whether or not the restoration factor is reception of data from the network I/F 102 or the USB I/F 114. If it is determined, in step S504, that the restoration factor is reception of data from the network I/F 102 or the USB I/F 114, the procedure advances to step S505, and otherwise to step S506.

In step S505, the CPU 101 lets the configuration controller 130 reconfigure the PDL print job image processing Configuration 204 on the dynamic reconfiguration unit 131. Here, the reason why the PDL print job image processing Configuration 204 is reconfigured is that a print job is likely to be instructed externally via the network I/F 102 or the USB I/F 114.

In step S506, the CPU 101 determines whether or not the restoration factor is reception of a CI signal. If it is determined in step S506 that the restoration factor is reception of a CI signal, the procedure advances to step S507. In step S507, the CPU 101 lets the configuration controller 130 reconfigure the FAX image processing Configuration 206 on the dynamic reconfiguration unit 131. The reason why the FAX image processing Configuration is reconfigured in step S506 is that the restoration factor of the present embodiment is reception of a CI signal, and thus a FAX job is then to be processed.

On the other hand, if it is determined in step S506 that the restoration factor is not reception of a CI signal, the CPU 101 ends the processing without changing the dynamic reconfiguration unit 131. Restoration factors in step S506 other than the reception of a CI signal include, for example, a factor that a user presses down a power key to perform shut-down processing, and the like. In this case, since the CPU 101 does not need to change the Configuration of the dynamic reconfiguration unit 131, the CPU 101 ends the flow without changing the configuration. Note that in the processing of steps S503, S505, and S507 of the present flowchart, the configuration controller 130 functions as the first reconfiguration unit.

As described above, it is possible to reconfigure an appropriate image processing function on the dynamic reconfiguration unit 131 according to the restoration factor when the image processing apparatus is restored from the power saving state, and to immediately start corresponding processing when a job execution instruction is given.

Job Execution Control

Hereinafter, reference will be made to FIG. 6, which is a flowchart showing the job execution control in the image processing apparatus 100 according to the present embodiment. The processing that will be described below is realized by the CPU 101 executing a control program stored in the ROM 104 on the RAM 111.

First, in step S601, the CPU 101 determines whether or not a job has been received. If it is determined that a job has been received, the procedure advances to step S602, and if it is determined that a job has not been received, the determination in step S601 is repeated regularly.

In step S602, the CPU 101 checks the type of the received job. Furthermore, in step S603, the CPU 101 checks a current image processing function that is reconfigured on the dynamic reconfiguration unit 131. In step S604, the CPU 101 determines whether or not the received job checked in step S602 is executable in the current image processing Configuration checked in step S603. If it is determined in step S604 that the received job is executable by the current image processing function reconfigured on the dynamic reconfiguration unit 131, the procedure advances to step S605, and if the received job is not executable, the procedure advances to step S606.

In step S605, the CPU 101 starts processing of the received job since the received job is executable. On the other hand, in step S606, the CPU 101 lets the configuration controller 130 reconfigure the image processing function that is needed for execution of the received job on the dynamic reconfiguration unit 131. Here, the configuration controller 130 functions as the second reconfiguration unit. If the reconfiguration of the image processing function that is needed for execution of the job is completed in step S606, the procedure advances to step S605, where the processing of the received job starts.

As described above, the image processing apparatus according to the present embodiment can reconfigure, on the dynamic reconfiguration unit 131, an appropriate image processing function according to the restoration factor when being restored from the power saving state, and it is possible to immediately start processing when a job execution instruction is given.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-035996 filed on Feb. 26, 2013, which is hereby incorporated by reference herein in its entirety.

What is claimed is:

1. An image processing apparatus including a reconfigurable circuit in which a part of a circuit arrangement is dynamically reconfigurable, the image processing apparatus comprising:
a status determination unit configured to determine a status when the image processing apparatus is activated;
a first reconfiguration unit configured to reconfigure a circuit arrangement for executing a job that is highly likely to be instructed from a circuit arrangement that has already been configured on the reconfigurable circuit based on the status determined by the status determination unit;
an accepting unit configured to accept a job;
a second reconfiguration unit configured to reconfigure, if the job accepted by the accepting unit is not executable by the circuit arrangement configured on the reconfigurable circuit, a circuit arrangement that is needed for execution of the job on the reconfigurable circuit; and
an execution unit configured to execute the job accepted by the accepting unit.

2. The image processing apparatus according to claim 1,
wherein the status is existence or absence and a type of an interface that is connected to the image processing apparatus when the image processing apparatus is turned on.

3. The image processing apparatus according to claim 2,
wherein the type of the interface includes a network interface, a USB interface, and a facsimile interface, and
when the image processing apparatus is turned on, the first reconfiguration unit reconfigures a circuit arrangement for executing a copy job on the reconfigurable circuit if the interface that is connected to the image processing apparatus does not exist,
the first reconfiguration unit reconfigures a circuit arrangement for executing a print job on the reconfigurable circuit if the interface that is connected to the image processing apparatus is the network interface or the USB interface, and
the first reconfiguration unit reconfigures a circuit arrangement for executing a facsimile job on the reconfigurable circuit if the interface that is connected to the image processing apparatus is the facsimile interface.

4. The image processing apparatus according to claim 2, further comprising:
a holding unit configured to hold in advance a priority order that is used, if a plurality of interfaces are connected to the image processing apparatus, to decide which interface-associated circuit arrangement is to be configured on the reconfigurable circuit when the image processing apparatus is turned on,
wherein the first reconfiguration unit decides, if a plurality of interfaces are connected to the image processing apparatus, the circuit arrangement that is to be reconfigured on the reconfigurable circuit based on the priority order held by the holding unit when the image processing apparatus is turned on.

5. The image processing apparatus according to claim 1,
wherein the status is a restoration factor that restores the image processing apparatus from a power saving state.

6. The image processing apparatus according to claim 5,
wherein the restoration factor includes an operation of an operation unit of the image processing apparatus, an instruction from an external apparatus via an interface, and reception of a calling signal from a telephone public circuit network,
the first reconfiguration unit reconfigures a circuit arrangement for executing a copy job on the reconfigurable circuit if the restoration factor is an operation of the operation unit of the image processing apparatus,
the first reconfiguration unit reconfigures a circuit arrangement for executing a print job on the reconfigurable circuit if the restoration factor is an instruction from an external apparatus via an interface, and
the first reconfiguration unit reconfigures a circuit arrangement for executing a facsimile job on the reconfigurable circuit if the restoration factor is reception of a calling signal.

7. The image processing apparatus according to claim 6,
wherein the first reconfiguration unit does not perform reconfiguration from the circuit arrangement that has already been configured on the reconfigurable circuit if the restoration factor is none of the operation of the operation unit of the image processing apparatus, the instruction from an external apparatus via an interface, and the reception of a calling signal.

8. The image processing apparatus according to claim 1, further comprising a storage unit configured to store information on each circuit arrangement in advance,
wherein the first reconfiguration unit and the second reconfiguration unit reconfigure circuit arrangements of the reconfigurable circuit using the information stored in the storage unit.

9. A method for controlling an image processing apparatus including a reconfigurable circuit in which a part of a circuit arrangement is dynamically reconfigurable, the method comprising the steps of:
determining a status when the image processing apparatus is activated;
firstly reconfiguring a circuit arrangement for executing a job that is highly likely to be instructed from a circuit arrangement that has already been configured on the reconfigurable circuit based on the status determined in the determining;
accepting a job;
secondly reconfiguring, if the job accepted in the accepting is not executable by the circuit arrangement configured on the reconfigurable circuit, a circuit arrangement that is needed for executing the job on the reconfigurable circuit; and
executing the job accepted in the accepting.

10. A non-transitory computer-readable storage medium storing a computer program causing a computer to function as the image processing apparatus according to claim 1.
